(19) United States
(12) Patent Application Publication
(10) Pub. No.: US 2026/0283380 A1
(43) Pub. Date: Sep. 24, 2026

(54) MODULAR CHRISTMAS TREE DISPLAY SYSTEM

(71) Applicant: Jessie Bryan Davis, SR., Crumpler, NC (US)

(72) Inventor: Jessie Bryan Davis, SR., Crumpler, NC (US)

(21) Appl. No.: 19/560,903

(22) Filed: Mar. 9, 2026

Related U.S. Application Data
(60) Provisional application No. 63/775,393, filed on Mar. 21, 2025.

(51) Int. Cl. A47F 5/10; A01G 5/04; A47F 5/04; A47G 33/12

(52) U.S. Cl. CPC A47F 5/10; A47F 5/04; A01G 5/04; A47G 33/12

(57) ABSTRACT

A modular Christmas tree display system includes a plurality of modular base support connectors for forming a modular display system for retail displays. Each of the modular base support connectors including a central vertical receiving channel dimensioned to receive a vertical support member or a trunk of a Christmas tree. A plurality of horizontal receiving channels are arranged orthogonally around the central vertical receiving channel. Each horizontal receiving channel is dimensioned to receive a horizontal member formed from standard dimensional lumber. The modular base support connector is configured to interconnect multiple horizontal members to form an interconnected structural grid for the modular display system.

### CROSS-REFERENCE TO RELATED APPLICATIONS

This application claims benefit to U.S. Provisional Patent Application No. 63/775,393 filed on Mar. 21, 2025, entitled MODULAR CHRISTMAS TREE DISPLAY SYSTEM, which is incorporated by reference in its entirety.

### FIELD OF THE DISCLOSURE

The present disclosure relates to display stands and structural support systems for Christmas trees and other seasonal merchandise. More particularly, the disclosure concerns a modular, reconfigurable Christmas tree display system that utilizes standardized dimensional lumber and multi-directional structural connectors to provide an economical, scalable, and safe framework for displaying Christmas trees, wreaths, garlands, and related holiday products in retail environments.

### BACKGROUND

Generally speaking, retailers have traditionally displayed Christmas trees using welded steel frames, rebar grids, or individual tapered peg stands. However, large volume and big box retailers generally do not use welded frames at all because such structures are cost prohibitive, heavy, difficult to transport, and present safety and liability concerns. Instead, these retailers commonly place trees loosely into large bins or open containers, requiring customers or employees to manually lift each tree and hold it upright in order to evaluate its shape and quality. This practice is labor intensive, unsafe, and inefficient, often resulting in customer injuries, employee strain, and damage to the trees themselves. Across all retail formats, legacy display systems exhibit significant limitations, including limited capacity, instability when one or more trees are removed, susceptibility to tipping on uneven ground or in windy outdoor conditions, lack of modularity, and single purpose designs that cannot be reconfigured to display wreaths, garlands, or form storage corrals. Welded steel frames and rebar structures are expensive to fabricate, difficult to store, and cannot be easily repaired or modified, resulting in low reusability from season to season. Accordingly, there remains a need for a modular, scalable, and multi-use display system that reduces cost, improves safety, adapts to any retail layout, and provides superior stability for Christmas trees and related holiday merchandise.

There is therefore a need for a modular, scalable, and multi-use display system that overcomes the cost, safety, and operational limitations of existing Christmas tree display methods. Such a system should provide superior stability even when trees are removed, function reliably on uneven or outdoor surfaces, and eliminate the need for customers or employees to manually lift and hold trees upright. It should adapt to any retail footprint, support both tree and non-tree merchandise such as wreaths and garlands, reduce fabrication and transportation costs, and offer a reusable, reconfigurable alternative to the welded frames, rebar grids, and bin based methods currently used in the industry.

The present disclosure may address the foregoing needs by providing a modular Christmas tree display system that overcomes the cost, safety, stability, and operational limitations of existing retail display methods. The disclosed system may employ multi-directional structural connectors and standardized dimensional lumber to create a reconfigurable, load sharing framework capable of securely supporting Christmas trees and a wide range of holiday merchandise in a variety of retail environments.

### SUMMARY

The present disclosure may provide a modular Christmas tree display system that addresses the limitations of existing retail display methods by employing a plurality of multi directional modular base support connectors. Each connector may include a central vertical receiving channel dimensioned to receive either a vertical support member or the trunk of a Christmas tree, and a plurality of horizontal receiving channels arranged orthogonally around the central channel. The horizontal receiving channels may be dimensioned to accept horizontal members formed from standardized dimensional lumber, enabling the connectors to interlock multiple horizontal members into a rigid, load sharing structural framework. When assembled, the connectors and horizontal members form an interconnected structural grid that provides enhanced stability, supports a wide range of display configurations, and enables safe, economical, and reconfigurable merchandising of Christmas trees and related holiday products.

In certain embodiments, each of the modular base support connectors may include four horizontal receiving channels arranged generally 90 degrees apart to form an orthogonal configuration. Other embodiments may use more or fewer channels or different orientations depending on the desired display layout.

One feature of the disclosed modular base support connectors may be that the horizontal receiving channels may include rectangular channels dimensioned to friction-fit standard 2×4 lumber. As such, in certain embodiments, the horizontal receiving channels of the modular base support connector may be formed as generally rectangular channels sized to friction fit standard 2×4 dimensional lumber, thereby enabling rapid tool free assembly using readily available materials.

Another feature of the disclosed modular base support connectors may be that they can be formed of a metal material, including, but not limited to, steel, aluminum, and galvanized steel. As such, in certain embodiments, the modular base support connectors may be formed from any suitable material capable of providing structural performance comparable to that of a standard wooden 2×4 used in the display system.

In select embodiments, each of the disclosed modular base support connector may include a top member and a base plate. The top member may form a top and sides of each of the horizontal receiving channels. The base plate may be affixed to the top member to form a bottom of each of the horizontal receiving channels. In select embodiments of the modular base support connectors, the base plate may be a solid plate without perforations. As such, the modular base support connectors may be used to form a bin or corral for holding trees, wreaths, garland, or other merchandise staged for replenishing the display area. In such bin or corral configurations, the top member may define the top and side surfaces of the horizontal receiving channels, and the base plate may define the bottom surfaces of the channels. In other embodiments used for the primary display grid, the modular base support connectors may be open topped and need not include a top member. In some versions, the base plate may be formed as a solid, non perforated plate.

Another feature of the disclosed modular base support connectors may be that in select embodiments they can be symmetrical about at least one axis. Having the base support connectors symmetrical about at least one axis may permit assembly of the modular display system in multiple directions. Such symmetry may allow the modular display system to be assembled or extended in multiple directions without requiring orientation specific components.

In select embodiments of the disclosed modular base support connectors, reinforcing ribs or gussets may be integrally formed with the horizontal receiving channels. As such, in certain embodiments, reinforcing ribs or gussets may be included as an optional manufacturing feature; however, the modular base support connectors may be designed and configured as inherently rigid and may not require additional reinforcement for normal operation.

In select embodiments of the disclosed modular base support connectors, the central vertical receiving channel may include a round channel. The round channel of the central vertical receiving channel may be dimensioned for supporting a round vertical support member or the trunk of the Christmas tree. In select embodiments, the round vertical support member may include a pole structure. The pole structure may be configured for connecting an additional modular base support connector above the modular base support connector for creating a multi-level modular display system. Or in other embodiments, the modular base support connector may be configured to support and display the Christmas tree in a vertical orientation when the trunk of the Christmas tree is inserted into the round channel of the central vertical receiving channel. As such, in certain embodiments, the central vertical receiving channel may be formed as a generally round channel sized to receive either the trunk of a Christmas tree or a round vertical support member. When a round vertical support member is used, it may function as a pole structure for supporting elevated displays of wreaths, garland, or other greenery items, or for other desired purposes, like carrying overhead lighting or signage above the display area. When the trunk of a Christmas tree is inserted into the round channel, the connector may support the tree in an upright orientation

In another aspect, the instant disclosure embraces a modular display system comprising a plurality of the modular base support connectors interconnected via a plurality of the horizontal members. Each of the plurality of modular base support connectors may be included in any of the various embodiments and/or combinations of embodiments shown and/or described herein.

In another aspect, the present disclosure embraces a modular display system for supporting Christmas trees and other holiday merchandise. The modular display system may include multiple modular base support connectors, each of which may be any of the embodiments or combinations of embodiments described herein. Each connector may include a central vertical receiving channel sized to receive either a vertical support member or the trunk of a Christmas tree, and a plurality of horizontal receiving channels arranged orthogonally around the central channel. The horizontal receiving channels may be dimensioned to receive horizontal members formed from standard dimensional lumber. When the horizontal members are inserted into the horizontal receiving channels of adjacent connectors, the connectors and horizontal members may form an interconnected structural grid configured to support multiple Christmas trees in an upright orientation. As additional connectors and horizontal members are added, the interconnected grid may increase in overall structural rigidity due to distributed load sharing across the system.

One feature of the disclosed modular display system may be that the interconnected structural grid can be expandable in at least two orthogonal directions. Because each modular base support connector may include horizontal receiving channels arranged at right angles, additional connectors and horizontal members can be added in multiple directions to enlarge the display footprint while maintaining overall structural rigidity.

Another feature of the disclosed modular display system may be that the interconnected structural grid can be configured to provide distributed load-sharing such that stability increases as additional modular base support connectors and horizontal members are added. As the grid expands, loads applied at any one connector may be transferred through the horizontal members to adjacent connectors, reducing localized stress and increasing the rigidity of the system as a whole.

Another feature of the disclosed modular display system may be that the modular display system can be configured to support at least 4 of the Christmas trees in the vertical orientation. The normal minimum may be 4 trees but could be as many as needed. As such, the modular display system may be configured to support multiple Christmas trees in an upright orientation, including configurations supporting as few as four trees and scalable to support substantially larger quantities as additional base support connectors and horizontal members are added.

Another feature of the modular display system is that the interconnected structural grid may remain stable when one or more Christmas trees are removed. The structural rigidity of the system may be provided by the modular base support connectors and the horizontal members, such that the presence or absence of individual trees does not materially affect the stability of the grid.

Another feature of the modular display system is that the interconnected structural grid may be configured to resist tipping when placed on uneven ground. Because stability is provided by the base support connectors and the horizontal members rather than by the trees themselves, the system can maintain a stable, balanced support structure even when the underlying surface is irregular.

Another feature of the modular display system is that the interconnected structural grid may be configured to resist wind induced tipping. Because stability is provided by the base support connectors and the horizontal members rather than by the trees themselves, wind forces acting on individual trees may be distributed across the grid, reducing the likelihood of tipping under windy conditions

In select embodiments, the modular display system may further include one or more vertical support members. Each vertical support member may be inserted into the central vertical receiving channel of a corresponding modular base support connector. In these embodiments, hooks or other mounting hardware may be attached to the vertical support members and configured to support the display of wreaths, garland, or other greenery items, or the like on the modular display system.

In select embodiments of the modular display system, the modular base support connectors, the horizontal members, and the vertical support members may be connected together to form a corral for storing baled or unbaled Christmas trees in the vertical orientation. In such corral configurations, the interconnected structural grid may define one or more enclosed or partially enclosed areas suitable for holding trees awaiting placement within the primary display area.

Another feature of the modular display system is that it may be reconfigurable to display Christmas trees and wreaths simultaneously. By combining upright tree supporting connectors with one or more vertical support members equipped with hooks or mounting hardware, the system may provide integrated merchandising of both trees and greenery within the same structural grid.

In another aspect, the present disclosure embraces a method of displaying Christmas trees in a retail environment. The method may include utilizing any of the disclosed modular base support connectors, in any of the embodiments or combinations of embodiments described herein, to form a modular display system. The method may include providing a plurality of modular base support connectors, each comprising a central vertical receiving channel dimensioned to receive either a vertical support member or the trunk of a Christmas tree, and a plurality of horizontal receiving channels arranged orthogonally around the central vertical receiving channel, each horizontal receiving channel being dimensioned to receive a horizontal member formed from standard dimensional lumber. The method may further include providing a plurality of horizontal members formed from standard dimensional lumber. With the provided connectors and horizontal members, the method may include positioning the modular base support connectors on a surface, inserting the horizontal members into the horizontal receiving channels of adjacent connectors to form an interconnected structural grid, and placing the trunks of Christmas trees into the central vertical receiving channels of at least some of the connectors. The interconnected structural grid formed by the connectors and horizontal members may provide distributed load sharing that stabilizes the Christmas trees independently of the presence or absence of adjacent trees.

In select embodiments of the disclosed method of displaying Christmas trees, a plurality of vertical support members may also be provided. In these embodiments, the disclosed method of displaying Christmas trees may further include the steps of: inserting the vertical support members into the central vertical receiving channel of at least some of the modular base support connectors; and hanging wreaths or garland from the vertical support members via hooks or mounting hardware on the vertical support members.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is an isometric view of a modular base support connector of the disclosed modular Christmas tree display system according to select embodiments of the instant disclosure;

FIG. 2 is a partially disassembled exploded isometric view of the modular base support connector from FIG. 1;

FIG. 3 is a top view of the modular base support connector of FIG. 1;

FIG. 4 is a side view of the modular base support connector of FIG. 1;

FIG. 5 is a bottom view of the modular base support connector of FIG. 1;

FIG. 6 is an isometric view of the disclosed modular Christmas tree display system according to select embodiments of the instant disclosure partially assembled in a 3×2 base configuration;

FIG. 7 is an isometric view of the modular Christmas tree display system of FIG. 6 fully assembled in the 3×2 base configuration;

FIG. 8 is a top view of the disclosed modular Christmas tree display system according to select embodiments of the instant disclosure showing a large retail store display base configuration;

FIG. 9 is an isometric view of the disclosed modular Christmas tree display system according to select embodiments of the instant disclosure with a 3×2 base configuration with Christmas trees being mounted on some of the modular base support connectors (×4) and vertical display stands being mounted thereon the remaining modular base support connectors (×2).

FIG. 10 is an isometric view of the modular Christmas tree display system of FIG. 9 with Christmas trees mounted thereon some of the modular base support connectors (×4) and wreaths mounted on the vertical displays mounted on the other modular base support connectors (×2);

FIG. 11 is an isometric view of the modular Christmas tree display system of FIG. 9 with ornamental trees mounted thereon some of the modular base support connectors (×4) and wreaths mounted on the vertical displays mounted on the other modular base support connectors (×2);

FIG. 12 is an isometric view of the disclosed modular Christmas tree display system according to select embodiments of the instant disclosure assembled as two corrals for storing a plurality of Christmas trees in an upright position in each of the two corrals;

FIG. 13 is an isometric view of the modular Christmas tree display system of FIG. 12 assembled as two corrals with Christmas trees stored in one of the two corrals in an upright position;

FIG. 14 is a partially disassembled exploded isometric view of the modular Christmas tree display system according to select embodiments of the instant disclosure being assembled as a vertical display;

FIG. 15 is an isometric view of the modular Christmas tree display system from FIG. 14 fully assembled as the vertical display with wreaths hung thereon on each side; and

FIG. 16 is a flow diagram of a method of displaying Christmas trees in a retail environment according to select embodiments of the instant disclosure;

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

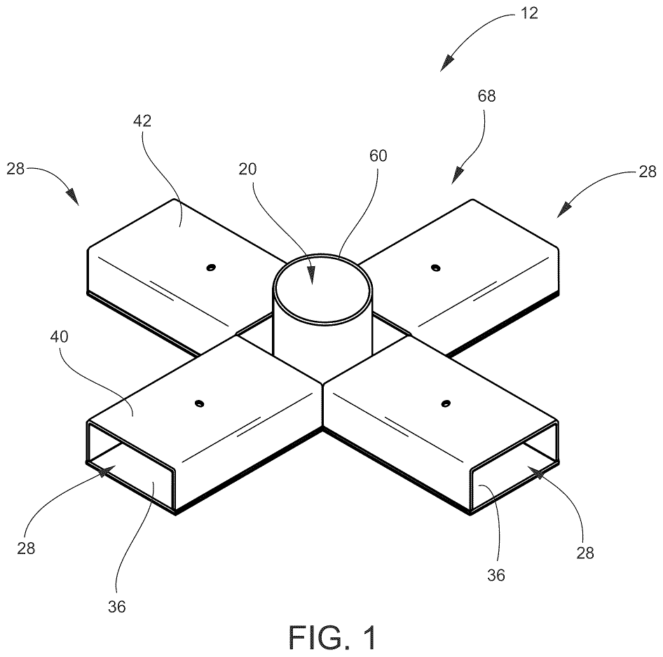

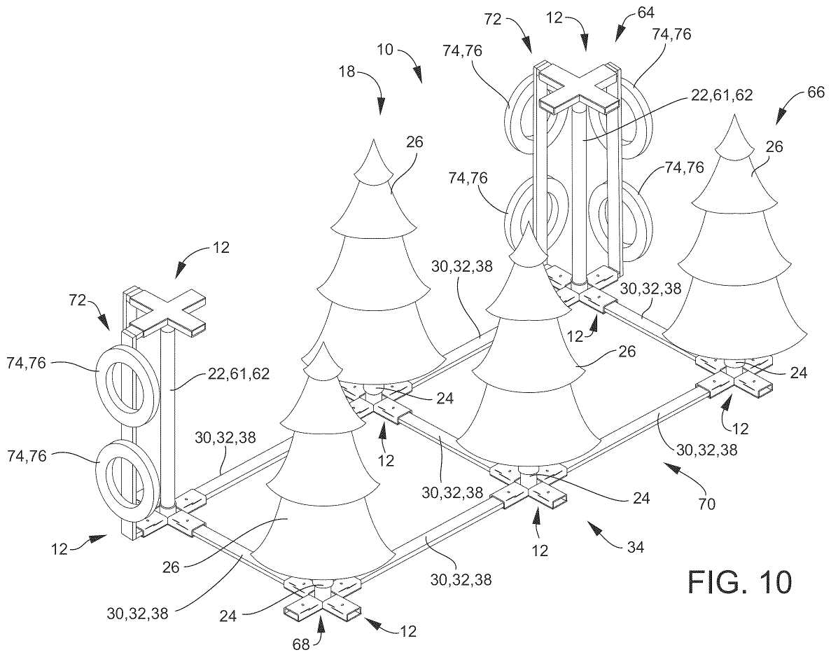

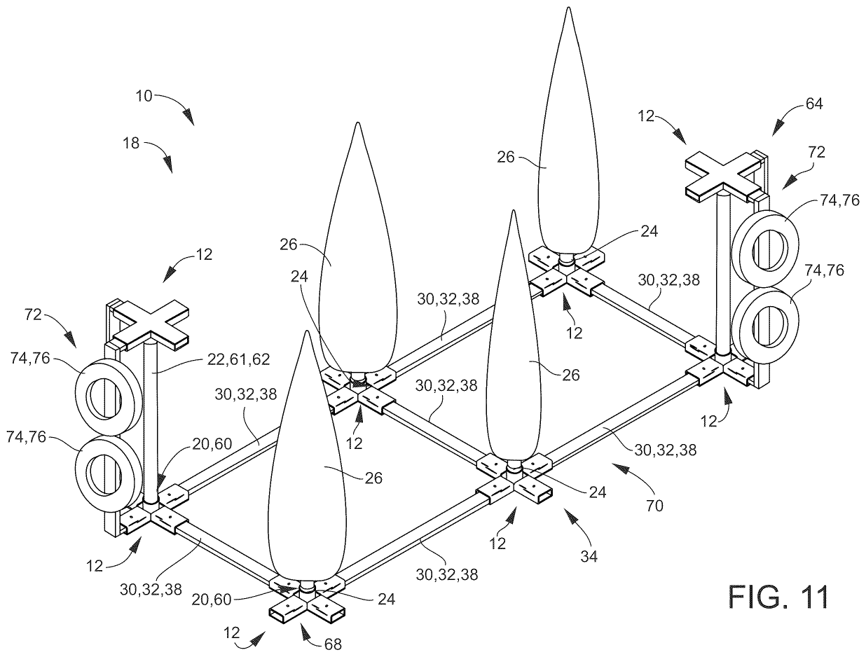

Referring now to FIGS. 1-16, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring to FIGS. 1-15, the present disclosure may solve the aforementioned limitations of the currently available retail display systems for Christmas trees, or the like, by providing modular Christmas tree display system 10, which may be referred to herein as just modular display system 10. Modular Christmas tree display system 10 may generally include a plurality of modular base support connectors 12. Modular base support connectors 12 may be the main component of modular Christmas tree display system 10 and may be configured for forming modular display system 10 for retail displays 18. Each of the modular base support connectors 12 may include central vertical receiving channel 20 dimensioned to receive vertical support member 22 or trunk 24 of Christmas tree 26, or the like. A plurality of horizontal receiving channels 28 may be arranged orthogonally, or at 90 degree angles, around central vertical receiving channel 20 of each of the modular base support connectors 12. Each horizontal receiving channel 28 may be dimensioned to receive horizontal member 30. Modular base support connectors 12 may be designed and configured so that horizontal receiving channels 28 are adapted to use standard dimensional lumber 32 as horizontal member 30. Wherein, modular base support connector 12 may be configured to interconnect multiple horizontal members 30 to form interconnected structural grid 34 or a rigid, load-sharing structural framework for modular display system 10.

As shown in the Figures, in select embodiments, and clearly not limited thereto, each modular base support connector 12 may include, but is not limited to, four (4) of the horizontal receiving channels 28 arranged at 90 degrees to one another. This configuration with four (4) horizontal receiving channels 28 included at 90 degrees to one another may be preferred to create various sizes and shapes of interconnected structural grid 34 with connections in two orthogonal directions 68. Horizontal receiving channels 28 may be sized, shaped, or configured to connect various sizes and shapes of horizontal members 30. A shown in the Figures, in select possibly preferred embodiments of the modular base support connectors 12, horizontal receiving channels 28 may include rectangular channels 36 dimensioned to friction-fit standard 2×4 lumber 38 as horizontal members 30, thereby enabling rapid assembly without tools. This embodiment and feature of modular base support connectors 12 may allow the user to use readily available pieces of 2×4 lumber 38 for interconnected structural grid 34 of modular display system 10. Modular base support connectors 12 of modular display system 10 may be formed or created out of any desired material. In select embodiments, the modular base support connectors 12 may be formed of metal material 40, as shown in the Figures. Metal material 40 used to create the modular base support connectors 12 may be, but it not limited to, steel, aluminum, galvanized steel, the like, or other desired load bearing materials.

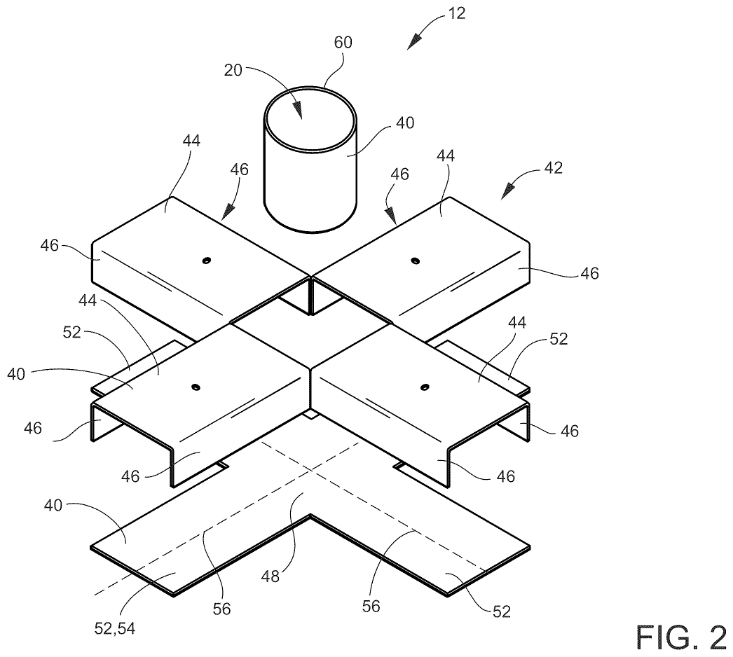

Referring now specifically to FIG. 2, in select embodiments, each of the disclosed modular base support connectors 12 may include top member 42 and base plate 48. Top member 42 may be designed, shaped, and/or formed to create top 44 and sides 46 of each of the horizontal receiving channels 28. Top member 42 may be, but is not limited to, a piece of sheet metal that is cut and bent to create top 44 and sides 46 of each of the horizontal receiving channels 28. Base plate 48 may be affixed to top member 42 to form bottom 52 of each of the horizontal receiving channels 28. In select embodiments of modular base support connectors 12, base plate 48 may be solid plate 54 without perforations, as best shown in FIG. 5. Still referring to FIG. 5, another feature of modular base support connectors 12 may be that in select embodiments they can be symmetrical about at least one axis 56. Having modular base support connectors 12 symmetrical about at least one axis 56 may permit assembly of modular display system 10 in multiple directions.

FIGS. 1 and 2 illustrate the core mechanical innovation for modular display system 10 of modular base support connector 12. As shown, modular base support connector 12 may provide a four way, load bearing connector engineered specifically to receive standard 2×4 lumber 38 for horizontal members 30. These four orthogonal 2×4 horizontal receiving channels 28 may enable horizontal structural members 30 (and vertical structural supports 22). A laser cut bottom base plate 48 may be provided with precise hole geometry for strength, drainage, and optional anchoring. Base plate 48 may be laser cut with drainage holes, anchoring holes, and structural reinforcement features. The symmetrical design of each modular base support connector 12 may allow assembly in any horizontal orientation. A vertical load path may be provided via central vertical receiving channel 20, which may be designed and configured to enable upright tree support and/or multi-level modular display system 64. Lateral load distribution through horizontal channels, may enable formation of interconnected structural grid 34 in various forms with distributed load sharing 70. As such, modular base support connector 12 is clearly not a generic bracket, as it is clearly designed and configured to provide a structural joint that enables the entire modular display system 10. No known prior art in Christmas tree displays uses a connector with this geometry or functionality.

Multiple modular base support connectors 12 may be joined using 2×4 lumber 38 as horizontal members 30 to form rigid interconnected structural grid 34. Interconnected structural grid 34 may: distribute vertical and lateral loads across the entire assembly; provide stability that increases with scale; allows trees to be displayed in rows, clusters, or custom layouts; can be expanded indefinitely in any direction; the like, etc.

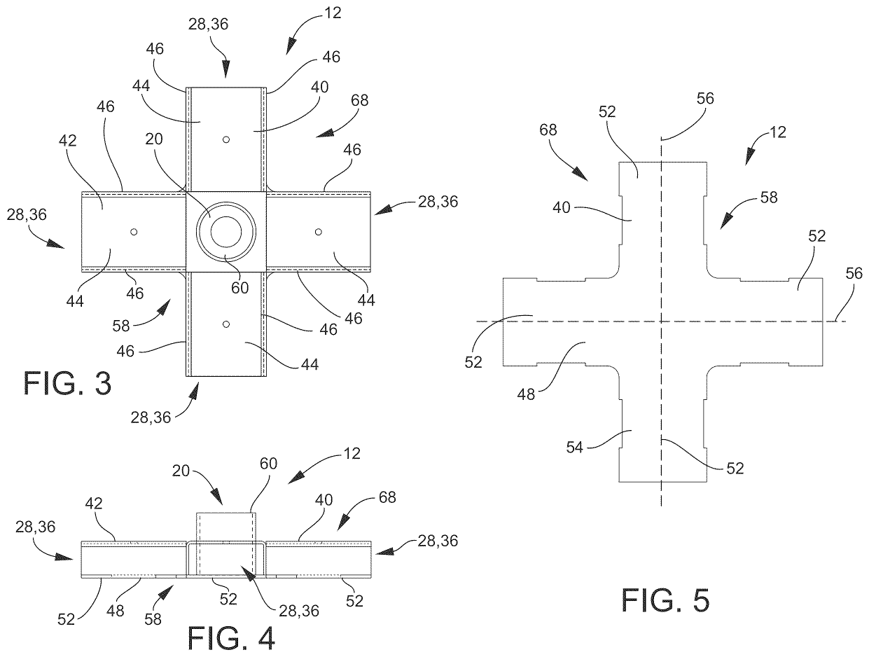

As best shown in FIGS. 3-5, in select embodiments of the modular base support connectors 12, reinforcing ribs or gussets 58 may be integrally formed with horizontal receiving channels 28. Reinforcing ribs or gussets 58 may be included to provide strength and rigidity to each horizontal receiving channel 28 and to modular base support connectors 12. In addition, reinforcing ribs or gussets 58 may provide for friction fitting of horizontal member 30 inside of each horizontal receiving channel 28, like standard dimensional lumber 32 or 2×4 lumber 38.

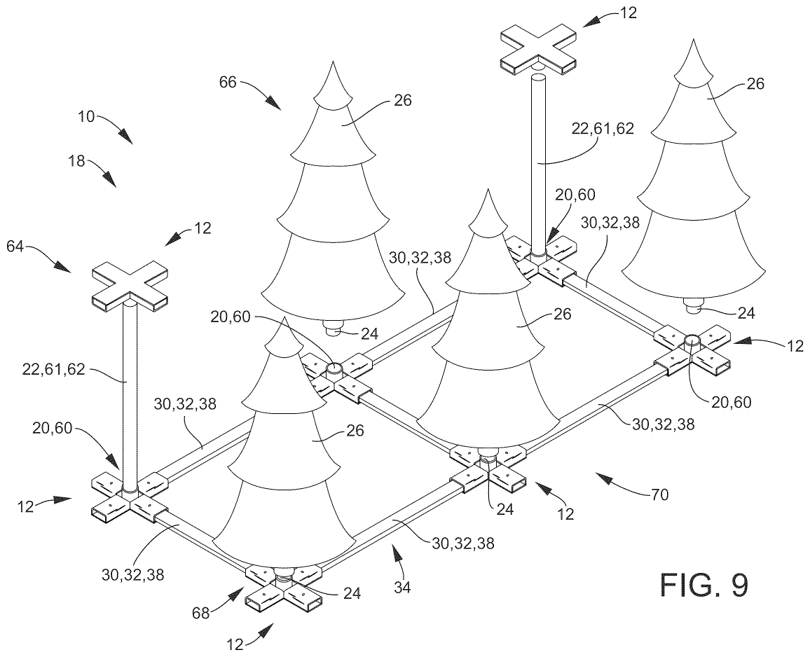

Referring to FIGS. 1-4, central vertical receiving channel 20 is shown. Central vertical receiving channel 20 of each modular base support connector 12 may be designed and configured to support a vertical support member 22 therein or trunk 24 of Christmas tree 26, or the like. In select embodiments of modular base support connectors 12, as shown in the Figures, but clearly not limited thereto, central vertical receiving channel 20 may include round channel 60. Round channel 60 of central vertical receiving channel 20 may be dimensioned for supporting round vertical support member 61 or trunk 24 of Christmas tree 26, or the like. In select embodiments, round vertical support member 61 may include pole structure 62, as shown in the Figures. Pole structure 62 may be configured for connecting an additional modular base support connector 12 above modular base support connector 12 for creating multi-level modular display system 64. The modular base support connector 12 connected above another modular base support connector 12 may be positioned upside town to insert pole structure 62, or the like, or other vertical support members 22 into central vertical receiving channel 20 of adjacent or stacked modular base support connectors 12 (see FIGS. 9-15). In other embodiments, modular base support connector 12 may be configured to support and display Christmas tree 26 in vertical orientation 66 when trunk 24 of Christmas tree 26 is inserted into round channel 60 of central vertical receiving channel 20 (see FIGS. 9, 10 and 11).

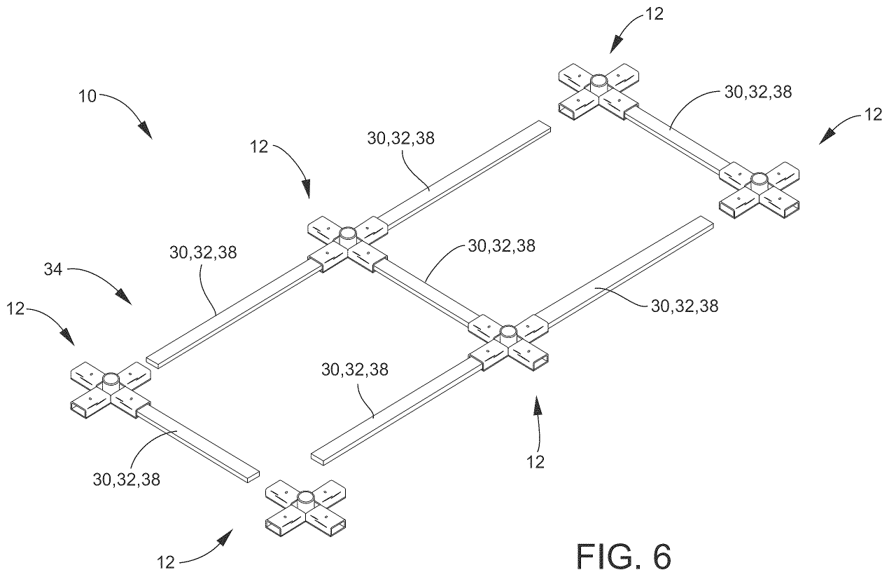

Referring to FIGS. 6-15, in another aspect, the instant disclosure embraces modular display system 10 comprising a plurality of the modular base support connectors 12 interconnected via a plurality of horizontal members 30. Each of the plurality of modular base support connectors 12 may be included in any of the various embodiments and/or combinations of embodiments shown and/or described herein. As such, in another aspect, the instant disclosure embraces modular display system 10 for supporting Christmas trees 26 and holiday merchandise, or the like, including, but not limited to, wreaths 74 and/or garland 76.

In general, modular display system 10 may include a plurality of the disclosed modular base support connectors 12, in any of the various embodiments and/or combinations of embodiments shown and/or described herein, including but not limited to, as shown in FIGS. 1-5. Wherein, multiple modular base support connectors 12 and horizontal members 30 may be connected together form interconnected structural grid 34 configured to support plurality of Christmas trees 26 in vertical orientation 66, or the like.

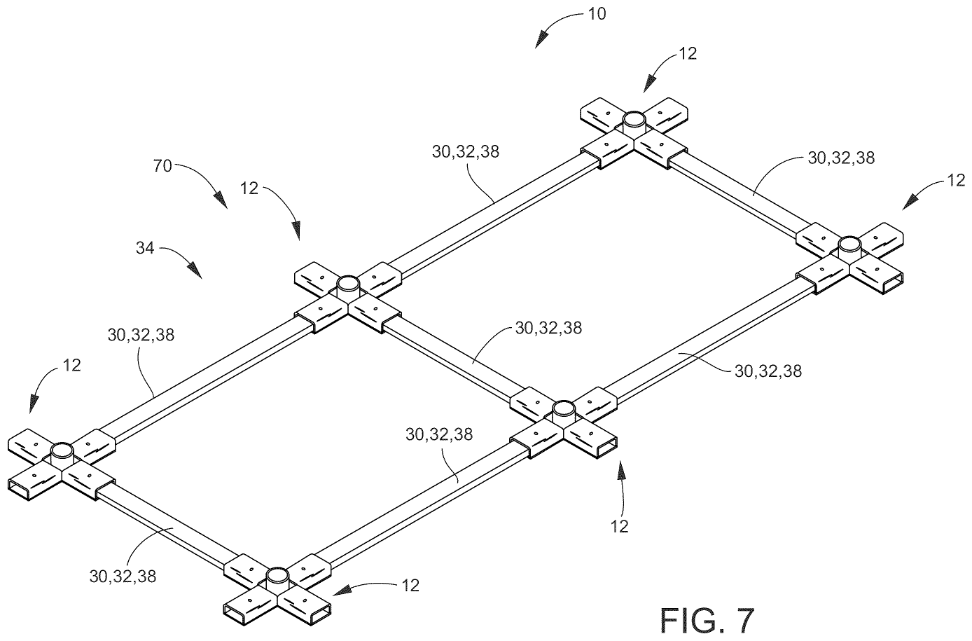

Referring specifically to FIGS. 6 and 7, a simple form of a modular floor grid with distributed load sharing 70 is shown. Thes Figures show the floor configuration assembly, which is central to the unexpected performance of modular display system 10. As shown, when multiple modular base support connectors 12 are joined with 2×4 lumber 38 as horizontal members 30, they form rigid, interconnected structural grid 34. This grid distributes loads across the entire structure rather than isolating each tree. The system becomes more stable as more trees are added—a counterintuitive result. The grid resists tipping even when trees are removed from one side. The structure remains stable on uneven ground and in wind. This distributed load sharing behavior is not present in traditional welded rebar stands, which support only four trees and become unstable when trees are removed. This is a major non-obviousness feature of modular display system 10.

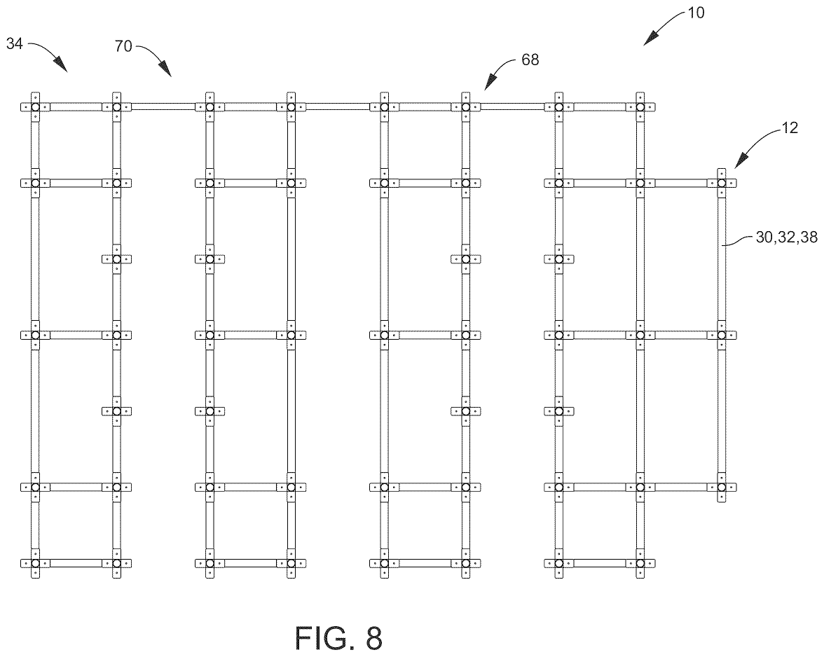

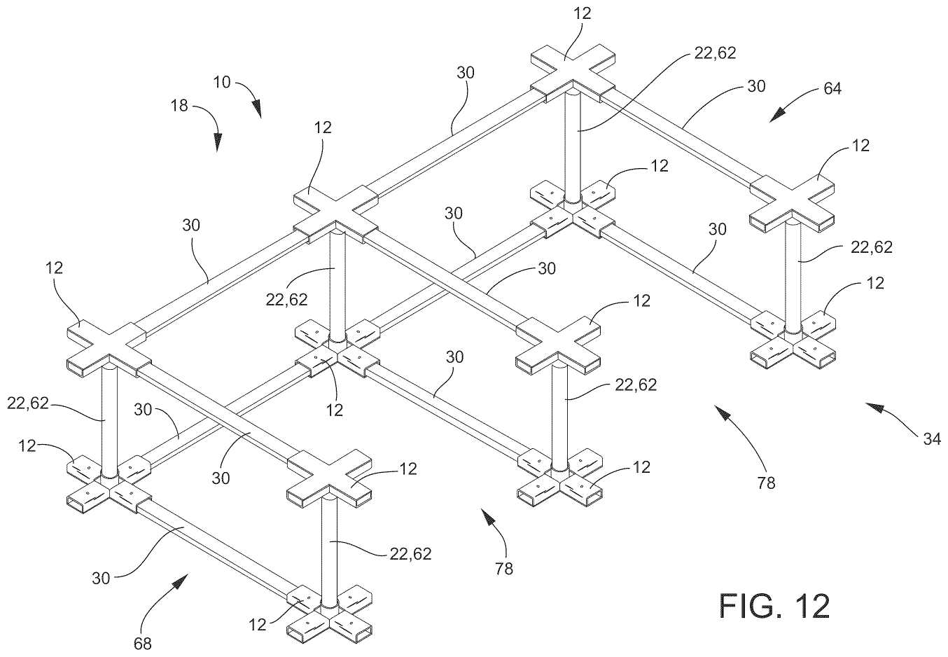

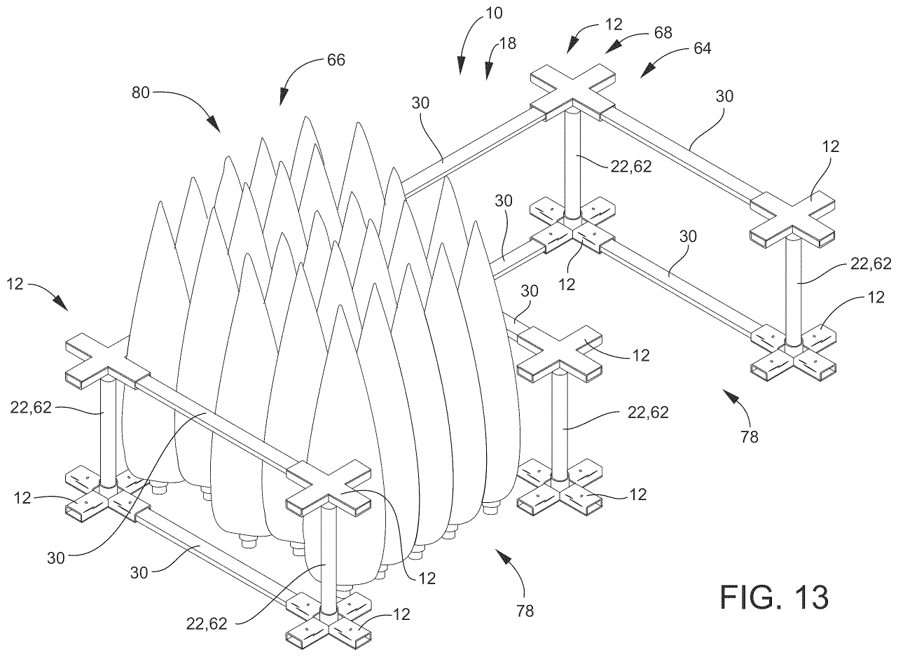

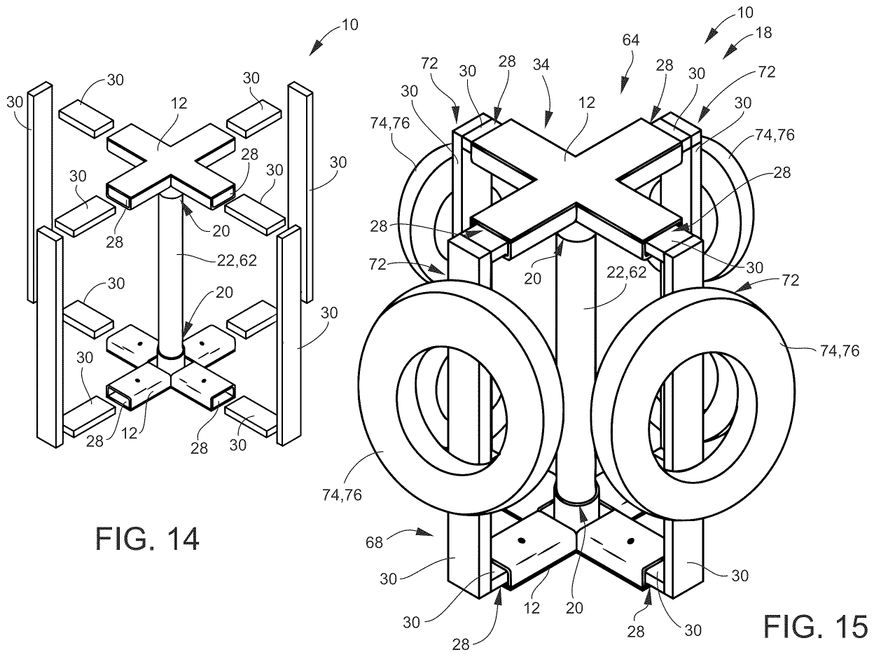

As best shown in FIG. 8, one feature of modular display system 10 may be that the interconnected structural grid 34 created via the plurality of modular base support connectors 12 and horizontal members 30 can be expandable in at least two orthogonal directions 68. As such, the interconnected structural grid 34 created via the plurality of modular base support connectors 12 and horizontal members 30 can expand in both orthogonal directions 68 to create various size, shapes and configurations for modular display system 10, including, but not limited to, the 3×2 configuration shown in FIGS. 6, 7, 9, 10, and 11, the large retail store display 18 shown in FIG. 8, the corral 78 configurations shown in FIGS. 12 and 13, and/or the decorations displays shown in FIGS. 14 and 15, like for wreaths 74, garland 76, the like, or other desired Christmas or other retail decorations or the like. As shown in these various embodiments, another feature of modular display system 10 may be that interconnected structural grid 34 can be configured to provide distributed load-sharing 70 such that stability increases as additional modular base support connectors 12 and horizontal members 30 are added. Another feature of modular display system 10 may be that modular display system 10 can be configured to support at least 6 of the Christmas trees 26 in vertical orientation 66. Another feature of disclosed modular display system 10 may be that modular display system 10 can remain stable when one or more of the Christmas trees 26 are removed. Another feature of modular display system 10 may be that modular display system 10 can be configured to resist tipping on uneven ground. Another feature of modular display system 10 may be that modular display system 10 can be configured to resist wind-induced tipping.

Referring now specifically to FIGS. 9-15, in select embodiments, modular display system 10 may further include at least one of the vertical support members 22. Each of the vertical support members 22 may be inserted into central vertical receiving channel 20 of one of the modular base support connectors 12. As shown in FIGS. 9, 10, 11, 14 and 15, in select embodiments, hooks or mounting hardware 72 may be attached to the at least one of the vertical support members 22. Hooks or mounting hardware 72 may be configured for displaying wreaths 74 or garland 76, or any other desired decorations or items, on modular display system 10.

FIGS. 9-11 demonstrates the ability of modular display system 10 to: hold pre milled trees upright, like Christmas trees 26 in vertical orientation 66; maintain consistent spacing; support trees of varying trunk diameters; and/or display large trees up to 10 feet tall. Traditional stands cannot safely support large trees in a retail environment. The ability to display large trees is a utility advantage and a commercially significant improvement provided by modular display system 10.

FIGS. 9-11 also show the ability of modular display system 10 to combine: Christmas trees 26, or the like, wreaths 74, garlands 76, storage areas, the like, etc. all within a single modular layout. This demonstrates: scalability; adaptability to any retail footprint; interchangeable structural roles of modular base support connectors 12, the like, etc. As such, modular display system 10 is truly unique and provides benefits over existing display systems because traditional systems cannot be reconfigured in this way.

Referring now specifically to FIGS. 12 and 13, in select embodiments of modular display system 10, modular base support connectors 12, horizontal members 30, and vertical support members 22 may be connected together to form a corral 78 or multiple corrals 78. Each corral 78 formed with modular base support connectors 12, horizontal members 30, and vertical support members 22 may be configured for storing baled or unbaled Christmas trees 80 in vertical orientation 66. FIGS. 12 and 3 show a configuration for storing baled or unbaled trees 80 prior to display. Prior art does not provide a modular corral system for tree storage. The same modular base support connectors 12 and 2×4 lumber 38 may be utilized to create a temporary storage enclosure via corrals 78. This reduces product damage and improves workflow for retailers. As a result, modular base support connectors 12 can be arranged to form a rectangular or polygonal enclosure, or corrals 78, for storing baled or unbaled trees 80. This configuration of modular display system 10 to include corrals 78 may: prevent trees from rolling or falling; improve workflow for retail staff; reduces product damage; the.

As shown in FIGS. 9, 10, and 11, another feature of modular display system 10 may be that it can be reconfigurable to display both Christmas trees 26 and wreaths 74 and/or garland 76 simultaneously. Or, as shown in FIGS. 14 and 15, of modular display system 10 may be configured to create a decorations display solely for such wreaths 74 and/or garland 76, the like, or other desired decorations or ornaments.

Referring specifically to FIGS. 14 and 15, these images demonstrate that the same connector system of modular display system 10 with modular base support connectors 12, horizontal members 30 of 2×4 lumber 38, and pole structures 62 for vertical support members 22 may be reconfigured to display: wreaths 74, garlands 76, or any other merchandise or holiday themed merchandise. This multi-use capability provided via modular display system 10 may not be found in existing tree display systems, which are single purpose. As such, modular display system 10 may provide: a modular holiday display system; a multi product merchandising framework; a reconfigurable retail display architecture; the like, etc. 2×4 lumber 38 for horizontal members 30 may be used to support hooks, pegs, or any other various mounting hardware 72 for wreaths 74, garlands 76, or the like. As such, modular display system 10 may: use the same modular base support connectors 12 as the tree display; allow vertical and horizontal merchandising; support high-density product placement; the like; etc.

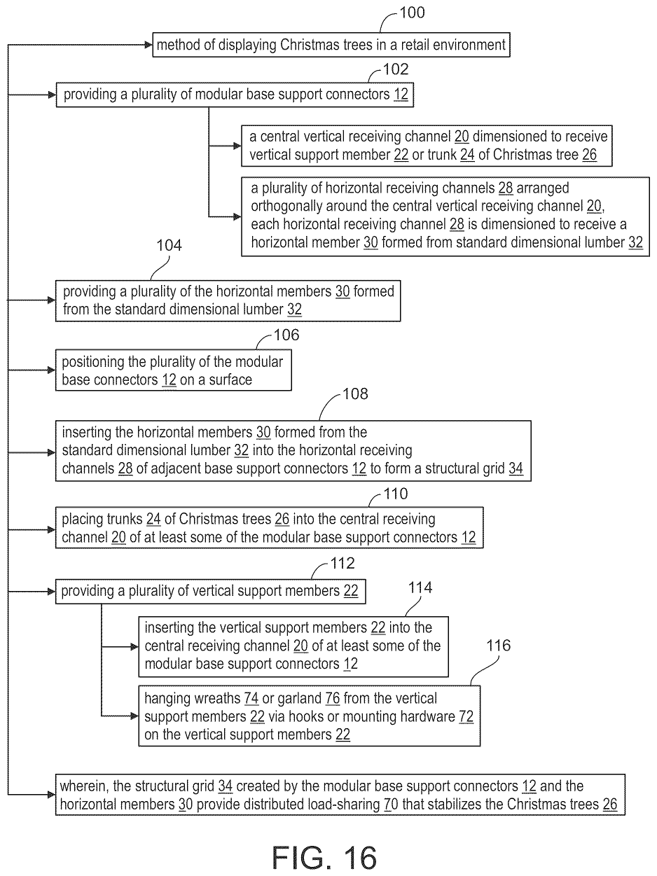

Referring now specifically to FIG. 16, in another aspect, the instant disclosure embraces method 100 of displaying Christmas trees 26 (or the like), like in retail environments on retail displays 18. Method 100 of displaying Christmas trees 26 (or the like) may generally included utilizing the disclosed modular base support connectors 12 in any of the embodiments and/or combinations of embodiments shown and/or described herein to form the disclosed modular display system 10 in any of the embodiments and/or combinations of embodiments shown and/or described herein. As such, method 100 of displaying Christmas trees 26 (or the like) in a retail environment may generally include step 102 of providing a plurality of the disclosed modular base support connectors 12. Method of displaying Christmas trees 26 (or the like) may also include step 104 of providing a plurality of the horizontal members 30 formed from standard dimensional lumber 32, including, but not limited to, standard 2×4 lumber 38, as shown in the Figures. With the provided plurality of modular base support connectors 12 and horizontal members 30, method 100 of displaying Christmas trees 26 (or the like) may also include the steps of: step 106 of positioning the plurality of the modular base support connectors 12 on a surface; step 108 of inserting the horizontal members 30 formed from the standard dimensional lumber 32 into the horizontal receiving channels 28 of adjacent modular base support connectors 12 to form interconnected structural grid 34; and step 110 of placing trunks 24 of Christmas trees 26 into central vertical receiving channel 20 of at least some of the modular base support connectors 12. Wherein, the interconnected structural grid 34 created by the modular base support connectors 12 and the horizontal members 30 provide distributed load-sharing 70 that stabilizes Christmas trees 26. In select embodiments of method 100 of displaying Christmas trees 26, a plurality of vertical support members 22 may also be provided via step 112. In these embodiments, method 100 of displaying Christmas trees 26 may further include the steps of: step 114 of inserting vertical support members 22 into central vertical receiving channel 20 of at least some of the modular base support connectors 12; and step 116 of hanging wreaths or garland from vertical support members 22 via hooks or mounting hardware 72 on vertical support members 22.

In use, modular display system 10 may be adaptable to many configurations for displaying Christmas Trees 26 in their upright position or vertical orientation 66 to allow for ease of viewing by potential customers. The main component of modular base support connectors 12 may be made of metal and may have horizontal receiving channels 28 on all four prongs for the insertion of 2×4 lumber 38 (or the like) of any length that is the desired distance between adjacent modular base support connectors 12 for retail displays 18. Modular base support connectors 12 could be used to insert upright vertical pole structure 62 to allow for the same and create multi-level modular display systems 64. Modular display system 10 may be simple and easy to erect using standard 2×4 connectors as horizontal members 30. Reuseable components may make it very cost effective for Large Retailers. Modular display system 10 can also be used to store baled or unbaled trees 80 prior to being displayed by creating corrals 78. Modular display system 10 can also be used to display other Christmas items such as wreaths 74 and garlands 76.

Example modular display systems 10 were created and tested in the field. Field tested performance data demonstrated: superior stability with no overturns occurred, even in wind or uneven terrain, stability increased as more trees were added, the system remained stable when trees were removed from one side; a high load capacity which safely supported large trees up to 10 feet tall, and supported dozens or even hundreds of trees in a single interconnected structure; safety improvements with reduced risk of customer injury, and reduced product damage; and operational efficiency with faster setup and teardown, no tools required, and lumber is inexpensive and replaceable. During field trials, modular display system 10 demonstrated: unexpected structural stability due to interconnected load paths; resistance to tipping even when trees were removed from one side; superior wind resistance compared to welded rebar stands; safe support for large trees up to 10 feet tall; and scalability to dozens or hundreds of trees. These real world results demonstrated the viability and practicality of modular display system 10 for use in retail displays 18.

The modular flexibility of modular display system 10 can be configured to any retailer's space thus making this a one system fits all for larger companies that has many stores with different configurations of the space they have to display their Christmas Trees 26 and other items. Modular display system 10 may be an innovative and adaptable solution designed for the economical and safe display of Christmas trees 26, or the like, in a retail environment. Modular display system 10 may utilize easily connected wooden 2×4's to allow retailers to configure their display areas according to their specific layout needs. Modular display system 10 can also be employed for displaying wreaths 74, garlands 76, and for temporary tree storage prior to being displayed.

Modular display system 10 may provide a modular design. This design may provide an interlocking design that includes modular components that can be easily connected and disconnected. Each component is designed to fit with standard wooden 2×4's, providing flexibility in display configurations. This design provides for customizable layouts, where stores can configure the display area to match their unique layout, ensuring optimal use of space and enhancing customer experience. Modular display system may provide multi-functional use with versatility and storage capabilities. In addition to displaying Christmas trees 26, modular display system 10 can be adapted to display wreaths 74, garlands 76, the like, and any other holiday decorations or other items. In addition, modular display system 10 can double as a storage solution, allowing retailers to store trees until they are ready to be displayed by creating corral 78 configurations. Modular display system 10 may be cost-effective by using economical materials and reusable components, as modular display system can be constructed from standard wooden 2×4's, making it cost-effective and accessible, and the modular components (modular base support connectors 12) are durable and reusable, reducing the need for frequent replacements and lowering long-term costs. The design of modular display system 10 may also provide ease of assembly with a user-friendly design designed for quick and easy assembly without the need for specialized tools or skills. In addition, an instruction guide may be included that can provide clear and concise steps for assembling and configuring the display system. Modular display system 10 may also be safe by providing a stable structure via the interlocking design that may ensure stability and prevents trees from tipping over, enhancing customer safety. Secure attachment points may be provided for additional stability of wreaths 74 and garlands 76.

In sum, modular Christmas tree display system 10 may be designed to provide an innovative and adaptable solution designed for the economical and safe display of Christmas trees 26 in a retail environment. Modular Christmas tree display system 10 may be designed to utilize easily connected wooden 2×4's to allow retailers to configure their display areas according to their specific layout needs. Modular Christmas tree display system 10 can also be employed for displaying wreaths, garlands, and for temporary tree storage prior to being displayed. In select embodiments or configurations, modular Christmas tree display system 10 may include a plurality of modular base support connectors, vertical supports interconnected between the plurality of modular base support connectors, horizontal supports interconnected between the plurality of modular base support connectors, the like, and/or combinations thereof. In select embodiments or configurations, modular Christmas tree display system 10 may further include upper horizontal connectors (same as modular base support connector). Modular Christmas tree display system 10 may be designed and/or configured to: be adaptable to many configurations for displaying Christmas Trees in their upright position thereby allowing for ease of viewing by potential customers; be simple and easy to erect using standard 2×4 connectors; include reuseable components, thereby making it very cost effective for large retailers; store unbaled trees prior to being displayed; display other Christmas items such as wreaths and garlands; any retailer's space thus making this a one system fits all for larger companies that have many stores with different configurations of the space they have to display their Christmas Tree and other items; the like; and/or combinations thereof.

Modular display system 10 may provide a modular Christmas tree display system comprising a plurality of multi directional modular base support connectors 12 configured to receive standard 2×4 lumber 38 in horizontal and vertical orientations. When assembled, the connectors and lumber form a rigid, load sharing structural grid 34 capable of supporting large numbers of Christmas trees 26, including trees up to 10 feet tall. A key advantage of modular display system 10 may be its distributed load sharing behavior, wherein the stability of the structure increases as additional trees and connectors are added. Field testing demonstrated that the interconnected grid resists tipping even when trees are removed from one side, and remains stable on uneven ground and in windy conditions. The same modular base support connectors 12 can be used to create tree display grids, storage corrals 78, wreath and garland racks, and mixed use configurations, enabling retailers to adapt the system to any available space. Modular display system 10 may be inexpensive to manufacture, easy to assemble without tools, and reusable year after year.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A modular base support connector for forming a modular display system for retail displays comprising:
a central vertical receiving channel dimensioned to receive a vertical support member or a trunk of a Christmas tree;
a plurality of horizontal receiving channels arranged orthogonally around the central vertical receiving channel, each horizontal receiving channel is dimensioned to receive a horizontal member formed from standard dimensional lumber; and
wherein the modular base support connector is configured to interconnect multiple horizontal members to form an interconnected structural grid for the modular display system.

2. The modular base support connector of claim 1 including four of the horizontal receiving channels arranged at 90 degrees to one another.

3. The modular base support connector of claim 1, wherein the horizontal receiving channels including rectangular channels dimensioned to friction-fit standard 2×4 lumber.

4. The modular base support connector of claim 1 being formed of a metal material selected from a group consisting of steel, aluminum, and galvanized steel.

5. The modular base support connector of claim 1 including:
a top member, the top member forming a top and sides of each of the horizontal receiving channels; and
a base plate, the base plate being affixed to the top member to form a bottom of each of the horizontal receiving channels.

6. The modular base support connector of claim 5, wherein the base plate is a solid plate without perforations.

7. The modular base support connector of claim 1, wherein the modular base support connector is symmetrical about at least one axis to permit assembly in multiple directions.

8. The modular base support connector of claim 1 further comprising reinforcing ribs or gussets integrally formed with the horizontal receiving channels.

9. The modular base support connector of claim 1, wherein the central vertical receiving channel including a round channel.

10. The modular base support connector of claim 9, wherein the round channel of the central vertical receiving channel is dimensioned for supporting a round vertical support member or the trunk of the Christmas tree;
the round vertical support member includes a pole structure, the pole structure is configured for connecting an additional modular base support connector above the modular base support connector for creating a multi-level modular display system; and
the modular base support connector is configured to support and display the Christmas tree in a vertical orientation when the trunk of the Christmas tree is inserted into the round channel of the central vertical receiving channel.

11. A modular display system comprising a plurality of the modular base support connector of claim 1 interconnected via a plurality of the horizontal members.

12. A modular display system for supporting Christmas trees and holiday merchandise comprising:
a plurality of modular base support connectors, each of the modular base support connectors comprising:
a central vertical receiving channel dimensioned to receive a vertical support member or a trunk of a Christmas tree;
a plurality of horizontal receiving channels arranged orthogonally around the central vertical receiving channel, each horizontal receiving channel is dimensioned to receive a horizontal member formed from standard dimensional lumber;
a plurality of the horizontal members formed from the standard dimensional lumber inserted into the horizontal receiving channels of adjacent modular base support connectors; and
wherein the modular base support connectors and the horizontal members form an interconnected structural grid configured to support a plurality of Christmas trees in a vertical orientation.

13. The modular display system of claim 12, wherein the interconnected structural grid is expandable in at least two orthogonal directions.

14. The modular display system of claim 12, wherein the interconnected structural grid is configured to provide distributed load-sharing such that stability increases as additional modular base support connectors and additional horizontal members are added.

15. The modular display system of claim 12, wherein:
the modular display system is configured to support at least 4 of the Christmas trees in the vertical orientation;
the modular display system remains stable when one or more of the Christmas trees are removed;
the modular display system is configured to resist tipping on uneven ground;
the modular display system is configured to resist wind-induced tipping; or
a combination thereof.

16. The modular display system of claim 12 further comprising:
at least one of the vertical support members inserted into the central vertical receiving channel of one of the modular base support connectors; and
hooks or mounting hardware attached to the at least one of the vertical support members, the hooks or mounting hardware are configured for displaying wreaths or garland on the modular display system.

17. The modular display system of claim 12, wherein the modular base support connectors, the horizontal members, and vertical support members are connected together to form a corral for storing baled or unbaled Christmas trees in the vertical orientation.

18. The modular display system of claim 12, wherein the modular display system is reconfigurable to display both the Christmas trees and wreaths simultaneously.

19. A method of displaying Christmas trees in a retail environment comprising:
providing a plurality of modular base support connectors, each of the modular base support connectors comprising:
a central vertical receiving channel dimensioned to receive a vertical support member or a trunk of one of the Christmas trees;
a plurality of horizontal receiving channels arranged orthogonally around the central vertical receiving channel, each horizontal receiving channel is dimensioned to receive a horizontal member formed from standard dimensional lumber;
providing a plurality of the horizontal members formed from the standard dimensional lumber;
positioning the plurality of the modular base support connectors on a surface;
inserting the horizontal members formed from the standard dimensional lumber into the horizontal receiving channels of adjacent modular base support connectors to form an interconnected structural grid;
placing trunks of the Christmas trees into the central vertical receiving channel of at least some of the modular base support connectors; and
wherein, the interconnected structural grid created by the modular base support connectors and the horizontal members provide distributed load-sharing that stabilizes the Christmas trees.

20. The method of claim 19 further comprising:
providing a plurality of vertical support members;
inserting the vertical support members into the central vertical receiving channel of at least some of the modular base support connectors; and
hanging wreaths or garland from the vertical support members via hooks or mounting hardware on the vertical support members.
